(19) United States
(12) Patent Application Publication
(10) Pub. No.: US 2020/0122578 A1
(43) Pub. Date: Apr. 23, 2020

(54) OUTPUT PROCESSING DEVICE AND OUTPUT PROCESSING METHOD

(71) Applicant: DENSO TEN Limited, Kobe-shi, Hyogo (JP)

(72) Inventor: Naoto MATSUSHITA, Kobe-shi (JP)

(73) Assignee: DENSO TEN Limited, Kobe-shi, Hyogo (JP)

(21) Appl. No.: 16/605,558

(22) PCT Filed: Jan. 26, 2018
(86) PCT No.: PCT/JP2018/002580

§ 371 Date: Oct. 16, 2019

(30) Foreign Application Priority Data
May 31, 2017 (JP) 2017-108692

(51) Int. Cl. B60K 35/00

(52) U.S. Cl. CPC B60K 35/00; B60K 2370/52

(57) ABSTRACT

An output processing device according to an embodiment includes reception, setting, decision, and adjusting units. The reception unit receives an output request including (i) output information to be output from at least one of a plurality of output units and (ii) information on a priority for outputting the output information. The setting unit sets a threshold of the priority for each of the plurality of output units. The decision unit decides from among the plurality of output units, based on the threshold set by the setting unit, an output destination of the output information included in the output request. The adjusting unit executes based on the priority, when the output unit, which is the output destination decided by the decision unit, is outputting other output information, an adjustment of whether to output, in an interrupted manner, the output information included in the output request received by the reception unit.

### FIELD

The embodiment discussed herein is directed to an output processing device and an output processing method.

### BACKGROUND

Recently, an output device provided in a vehicle, such as a display and a speaker, tends to increase. There presents an output processing device that decides, when pieces of information output from output devices compete with each other, which piece of information is to be preferentially output by an adjustment that is based on priorities allocated to the pieces of information.

### CITATION LIST

### Patent Literature

Japanese Laid-open Patent Publication No. 2002-225592

### SUMMARY

### Technical Problem

For example, in a case where a plurality of output devices is provided in a vehicle, it is preferable that information important for a driver is output from an output device located at a position in easy view for the driver, on the other hand, the information is not output to an output device located at a position in difficult view for the driver. In other words, it is desirable that output destinations of information are appropriately distributed so that a driver does not get confused.

However, in a conventional technology, for example, adjustments performed with respect to output devices have not been associated with each other, and thus there presents possibility that information having the same content is simultaneously output from a plurality of output devices. As described above, the above-mentioned conventional technology has room for improvement in appropriately distributing output destinations of information.

One aspect of the embodiment is made in view of the aforementioned, and an object of the embodiment is to provide an output processing device and an output processing method, which is capable of appropriately distributing output destinations of information.

### Solution to Problem

An output processing device according to an embodiment includes a reception unit, a setting unit, a decision unit, and an adjusting unit. The reception unit receives an output request including (i) output information that is to be output from at least one of a plurality of output units and (ii) information on a priority for outputting the output information. The setting unit sets a threshold of the priority for each of the plurality of output units. The decision unit decides from among the plurality of output units, based on the threshold set by the setting unit, an output destination of the output information included in the output request. The adjusting unit executes based on the priority, when the output unit, which is the output destination decided by the decision unit, is outputting other output information, an adjustment of whether to output, in an interrupted manner, the output information included in the output request received by the reception unit.

### Advantageous Effects of Invention

According to an aspect of the embodiment, it is possible to appropriately distribute output destinations of information.

### BRIEF DESCRIPTION OF DRAWINGS

FIG. 1A is a diagram illustrating a configuration of a vehicle according to an embodiment.

FIG. 1B is a diagram illustrating the outline of an output processing method according to the embodiment.

FIG. 2 is a block diagram illustrating a configuration of an output processing device according to the embodiment.

FIG. 3 is a diagram illustrating one example of information that is transmitted as an output request, to the output processing device, from an on-vehicle device according to the embodiment.

FIG. 4 is a diagram illustrating threshold information.

FIG. 5 is a diagram illustrating a set example of a threshold according to a margin degree.

FIG. 6 is a diagram illustrating processing details of an adjusting unit.

FIG. 7 is a diagram illustrating a switching example of an output unit.

FIG. 8 is a diagram illustrating a switching example of the output unit.

FIG. 9 is a flowchart illustrating a processing procedure for a process to be executed by the output processing device according to the embodiment.

FIG. 10 is a diagram illustrating a configuration of an output processing system according to the embodiment.

FIG. 11 is a diagram illustrating a configuration of the output processing system according to the embodiment.

### DESCRIPTION OF EMBODIMENTS

Hereinafter, an embodiment of an output processing device and an output processing method according to the present application will be described in detail with reference to the accompanying drawings. The present disclosure is not limited to the embodiment described in the following.

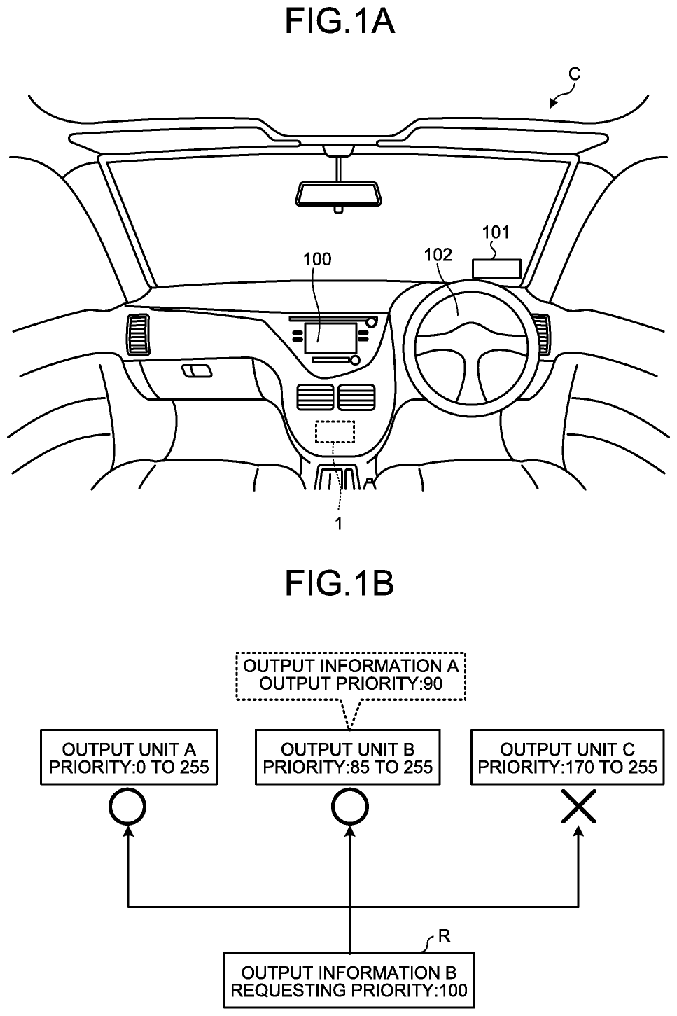

The outline of an output processing method according to the embodiment will be explained with reference to FIGS. 1A and 1B. FIG. 1A is a diagram illustrating a configuration of a vehicle C according to the embodiment. FIG. 1B is a diagram illustrating the outline of the output processing method according to the embodiment.

FIG. 1A is a diagram illustrating a front portion of the vehicle interior of the vehicle C. As illustrated in FIG. 1A, an output processing device 1 according to the embodiment is mounted on the vehicle C to execute the output processing method. On the vehicle C, a plurality of output units 100 to 102 is mounted and output information transmitted from the output processing device 1 is output therefrom.

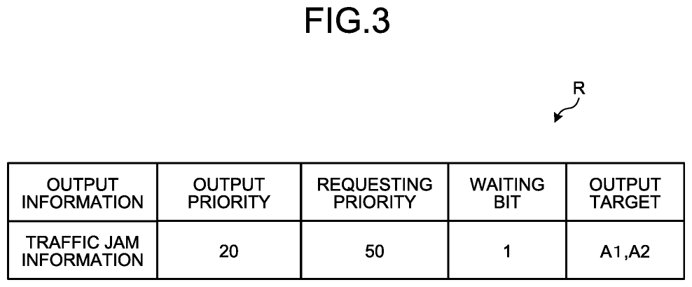

The output information is information to be output from any of the output units 100 to 102, such as information on a display screen and a sound. The output information is included in an output request that is output from any of a plurality of on-vehicle devices, this point will be mentioned later with reference to FIG. 3.

As illustrated in FIG. 1A, the output unit 100 is, for example, a center display that is arranged in a front center portion of the vehicle C. The output unit 101 is, for example, a head up display (HUD) that is arranged on a windshield of the vehicle C. The output unit 102 is, for example, a meter display including meters that is arranged in an instrument panel.

Positions and/or types of the output units 100 to 102 illustrated in FIG. 1A are merely examples; however, not limited thereto, the output units may include a rear display for a backseat of the vehicle C, for example.

In FIG. 1A, the three output units 100 to 102 are illustrated; however, the number of the output units 100 to 102 is not limited to three, and may be two or equal to or more than four. Hereinafter, the plurality of output units 100 to 102 may be collectively referred to as the output units 100.

In FIG. 1B, an adjustment method to be executed by the output processing device 1 according to the embodiment is illustrated. Moreover, in FIG. 1B, a case is illustrated in which an output request R including output information “B” is received during a time interval in which an output unit “B” is outputting output information “A”.

The adjustment indicates a process for deciding, when pieces of output information compete with each other in the predetermined output unit 100, which piece is preferentially output on the basis of priorities of the pieces. Specifically, explaining with reference to FIG. 1B, the adjustment is to compare an output priority of the output information “A” with a requesting priority of the output information “B” so as to preferentially output information having a larger numeric value.

The priority is information that includes two types of priorities of an output priority and a requesting priority, and indicates the importance of output information for a driver (user). In other words, as a priority of output information is higher, a driver is to be informed of the information more reliably. The output priority and the requesting priority will be mentioned later.

In the example illustrated in FIG. 1B, the output information “B” wins as a result of the adjustment, and thus the output processing device 1 according to the embodiment causes the output unit “B” to output, in an interrupted manner, the output information “B” instead of the output information “A” that is being output from the output unit “B”. Thus, it is possible to reliably inform a driver of information that is important for him/her even when pieces of output information compete with each other in the predetermined output unit 100.

Meanwhile, for example, when the plurality of output units 100 is provided in the vehicle C, it is preferable that information important for a driver is output from the output unit 100 located at a position in easy view for the driver, on the other hand, the information is not output from the output unit 100 located at a position in difficult view for the driver. In other words, it is desirable that output destinations of output information are appropriately distributed so that a driver does not get confused.

However, in a conventional technology, for example, adjustments performed with respect to output devices have not been associated with each other, and thus there presents possibility that information having the same content is simultaneously displayed on a plurality of output devices. As described above, the above-mentioned conventional technology has room for improvement in appropriately distributing output destinations of information.

Therefore, in the output processing device 1 according to the embodiment, a priority threshold is set for each of the output units 100 to 102. For example, in the example illustrated in FIG. 1B, the output processing device 1 according to the embodiment sets a priority “0 to 255” for an output unit “A”, sets a priority “85 to 255” for the output unit “B”, and sets a priority “170 to 255” for an output unit “C”.

The output processing device 1 according to the embodiment decides, on the basis of a set threshold, an output destination of the output information “B”, which is included in the output request R, from among the plurality of output units 100.

Specifically, a priority (requesting priority) of the output information “B” is “100”, and thus the output unit “A” and the output unit “B” are appropriate for an output destination, and the output unit “C” is not appropriate therefor.

Next, the output processing device 1 according to the embodiment preferentially executes an adjustment on the output unit “A” and the output unit “B” in order of the magnitude of the threshold. In other words, in the example illustrated in FIG. 1B, an adjustment is first executed on the output unit “B”. When the output information “B” wins as a result of the adjustment, the output processing device 1 according to the embodiment does not execute an adjustment on the output unit “A”.

As described above, when a priority threshold is set for each of the plurality of output units 100, it is possible to prevent the plurality of output units 100 from simultaneously outputting output information to be able to output information that is important for a driver from the appropriate output unit 100. In other words, the output processing device 1 according to the embodiment is capable of appropriately distributing output destinations of information.

When the output information “B” is defeated as a result of the adjustment, the output processing device 1 according to the embodiment executes again an adjustment on the output unit “A” that is the other output destination, this point will be mentioned later.

Moreover, the output processing device 1 according to the embodiment may make a priority threshold of each of the output units 100 variable in accordance with various conditions, this point will be mentioned later.

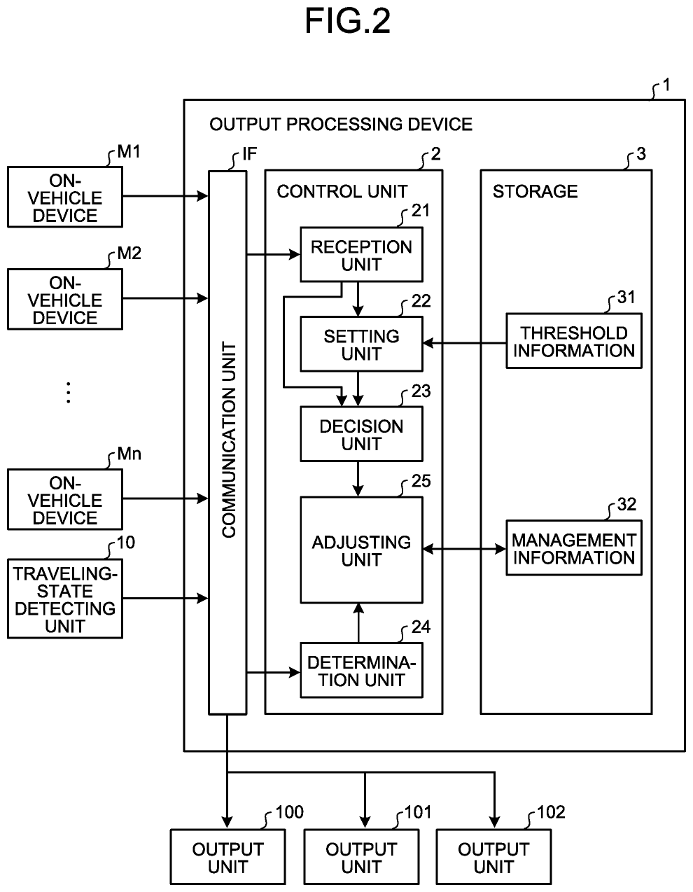

Next, with reference to FIG. 2, a configuration of the output processing device 1 according to the embodiment will be specifically explained. FIG. 2 is a block diagram illustrating the configuration of the output processing device 1 according to the embodiment. As illustrated in FIG. 2, the output processing device 1 according to the embodiment is connected to a plurality of on-vehicle devices M1 and M2 to Mn, the plurality of output units 100 to 102, and a traveling-state detecting unit 10.

The plurality of on-vehicle devices M1 and M2 to Mn includes, for example, a car navigation device, an audio device, a television device, a driver assistance device, a vehicle-to-vehicle communication device, a road-to-vehicle communication device, a traffic-information receiving device, and a portable terminal such as a smartphone and a mobile telephone. Each of the on-vehicle devices M1 and M2 to Mn outputs, to the output processing device 1, the output request R of output information in accordance with a user operation or a situation. Hereinafter, the plurality of on-vehicle devices M1 and M2 to Mn may be collectively referred to as on-vehicle devices M.

Common software according to a spec of the output processing device 1 is previously implemented in the on-vehicle devices M, and an output request and the like is transmitted to the output processing device 1 via the software.

When operated by a user, for example, the audio device and/or the television device transmits, to the output processing device 1, the output request R including output information, such as a screen and a sound that are according to his/her operation, and the like. When a goal is set, for example, a car navigation device transmits, to the output processing device 1, the output request R including output information on a screen indicating a route to the goal and the like, and when approaching a branch point on the route, the car navigation device transmits, to the output processing device 1, the output request R including output information on a screen and/or a sound for showing an advancing direction and the like.

The vehicle-to-vehicle communication device and the road-to-vehicle communication device transmit, to the output processing device 1, an output request including output information on a screen, a sound, and the like that indicate a state of another vehicle traveling in the vicinity of an own vehicle, for example. The traffic-information receiving device transmits, to the output processing device 1, an output request including output information on a screen, a sound, and the like that indicate traffic jam information and accident information in the vicinity of an own vehicle, for example.

When there presents an incoming call and/or a receipt of an e-mail for a user, for example, the portable terminal transmits, to the output processing device 1, an output request including output information on a screen, a sound, and the like regarding telephone answering and/or reading out of the e-mail, for example.

In this case, each of the on-vehicle devices M1 and M2 to Mn transmits, to the output processing device 1, the output request R including output information and information on a priority allocated to the output information. One example of information indicating the output request R transmitted to the output processing device 1 from the on-vehicle device M will be explained with reference to FIG. 3.

FIG. 3 is a diagram illustrating one example of information that is transmitted as the output request R, to the output processing device 1, from the on-vehicle device M according to the embodiment. In FIG. 3, a case is exemplified in which the on-vehicle device M is a traffic-information receiving device, and one example of information is illustrated in a case where the output request R is transmitted to the output processing device 1 when traffic jam information is received.

As illustrated in FIG. 3, the output request R includes items such as “output information”, “output priority”, “requesting priority”, “waiting bit”, and “output target”. The “output information” is information including contents of a screen and/or a sound to be output from the output unit and the like.

The “output priority” is information on a priority to be used in adjusting during output. The “requesting priority” is information on a priority to be used in an adjustment at an output request. The “waiting bit” is information indicating whether or not a suspension in a waiting buffer (to be mentioned later) is permitted, and “1” indicates that a suspension is permitted. The “output target” is information that specifies, from among the plurality of output units 100, the output unit 100 on which an adjustment is to be executed.

As illustrated in FIG. 3, when receiving traffic jam information, for example, the on-vehicle device M allocates an output priority “20” and a requesting priority “50” to “output information” including contents of the received traffic jam information. The on-vehicle device M sets, for the “output information”, a waiting bit “1”, specifies “A1 and A2” as the output units 100 of adjustment targets, and transmits the output request R to the output processing device 1.

As described above, a priority is allocated to output information such as traffic jam information that is necessary to be conveyed to a user comparatively immediately and has a low necessity for being continuously output once it has been output, such that a requesting priority becomes higher than an output priority.

Returning to FIG. 2, the output units 100 to 102 will be explained. Each of the output units 100 to 102 outputs output information transmitted from the output processing device 1. The output units 100 to 102 include a device that outputs image information, such as a liquid crystal display, and a device that outputs sound information, such as a speaker.

The traveling-state detecting unit 10 detects a traveling state of the vehicle C. Specifically, the traveling-state detecting unit 10 detects a traveling state including a traveling velocity, a turning angle, presence/absence of a stop of the vehicle C on the basis of values detected by various sensors such as a vehicle-speed sensor, an acceleration sensor, and a steering-angle sensor.

The output processing device 1 according to the embodiment includes a communication unit IF, a control unit 2, and a storage 3. The communication unit IF includes a communication interface that transmits/receives information to/from the on-vehicle devices M and the output units 100 to 102. The communication unit IF receives the output request R from the on-vehicle device M and outputs the received output request R to the control unit 2.

The control unit 2 includes a reception unit 21, a setting unit 22, a decision unit 23, a determination unit 24, and an adjusting unit 25. The storage 3 stores therein threshold information 31 and management information 32.

The output processing device 1 includes a computer that includes, for example, a Central Processing Unit (CPU), a Read Only Memory (ROM), a Random Access Memory (RAM), a Hard Disk Drive (HDD), an input/output port, etc.; and various circuits.

The CPU of the computer reads out and executes a program stored in the ROM, for example, so as to function as the reception unit 21, the setting unit 22, the decision unit 23, the determination unit 24, and the adjusting unit 25 of the control unit 2.

At least one or all of the reception unit 21, the setting unit 22, the decision unit 23, the determination unit 24, and the adjusting unit 25 of the control unit 2 may be constituted of hardware such as an Application Specific Integrated Circuit (ASIC) and a Field Programmable Gate Array (FPGA).

The storage 3 corresponds to the RAM and/or the HDD, for example. The RAM and the HDD are capable of storing therein the threshold information 31, the management information 32, information on various programs, and the like. The output processing device 1 may acquire the above-mentioned programs and various kinds of information via another computer connected thereto by a wired or wireless network and/or a portable recording medium.

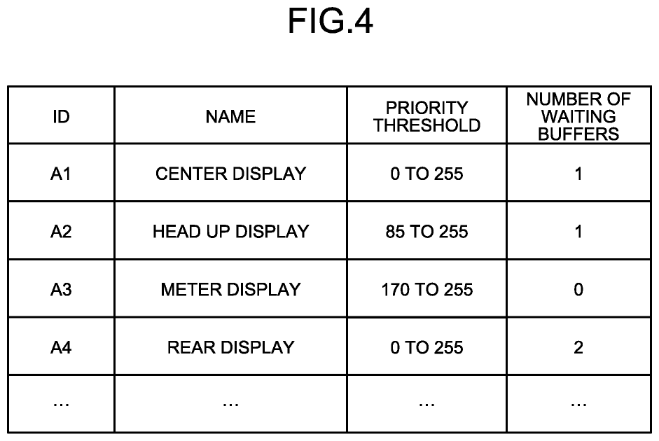

The threshold information 31 is information indicating a priority threshold that is set for each of the plurality of output units 100 to 102. The threshold information 31 will be explained with reference to FIG. 4. FIG. 4 is a diagram illustrating the threshold information 31.

As illustrated in FIG. 4, the threshold information 31 includes items such as “ID”, “name”, “priority threshold”, and “number of waiting buffers”. The “ID” is identification information for identifying each of the output units 100 to 102. The “name” indicates a name of each of the output units 100 to 102.

The “priority threshold” indicates a priority threshold to be set for each of the output units 100 to 102. In FIG. 4, a case is illustrated in which a maximum value of the priority is 255; however, the maximum value of the priority may be an arbitrary numeric value other than 255. The “number of waiting buffers” indicates the number of pieces of output information to be suspended in each of the output units 100 to 102.

For example, the output unit 100 whose ID is “A1” has a name of “center display” and its priority threshold is set to “0 to 255”. The waiting buffer of the output unit 100 whose ID is “A1” is “1”, in other words, one piece of output information is able to be suspended.

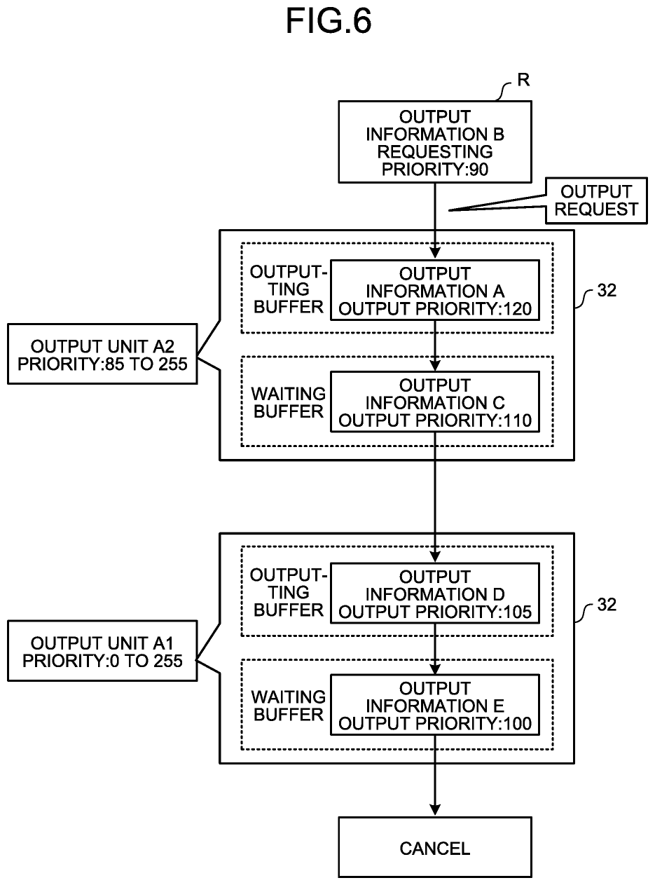

Returning to FIG. 2, the management information 32 will be explained. The management information 32 is information indicating a present outputting situation in each of the output units 100. The management information 32 includes an outputting buffer that stores therein output information presently being output and a waiting buffer that stores therein output information being suspended, and this point will be mentioned later with reference to FIG. 6.

The control unit 2 sets a priority threshold for each of the plurality of output units 100. The control unit 2 receives the output request R from the on-vehicle device M, and decides, on the basis of the priority threshold, the output unit 100 to be an output destination of output information included in the received output request R, so as to execute an adjustment.

The reception unit 21 receives the output request R from the on-vehicle device M via the communication unit IF, and outputs the received output request R to the decision unit 23. The reception unit 21 informs the setting unit 22 that the reception unit 21 receives the output request R.

When receiving a notification indicating that the reception unit 21 has received the output request R, the setting unit 22 sets, on the basis of the threshold information 31, a priority threshold for each of the output units 100. For example, the setting unit 22 sets values of “priority threshold” included in the threshold information 31. The setting unit 22 sets the values such that a value of the priority threshold is higher as a position is in easier view for the driver, for example.

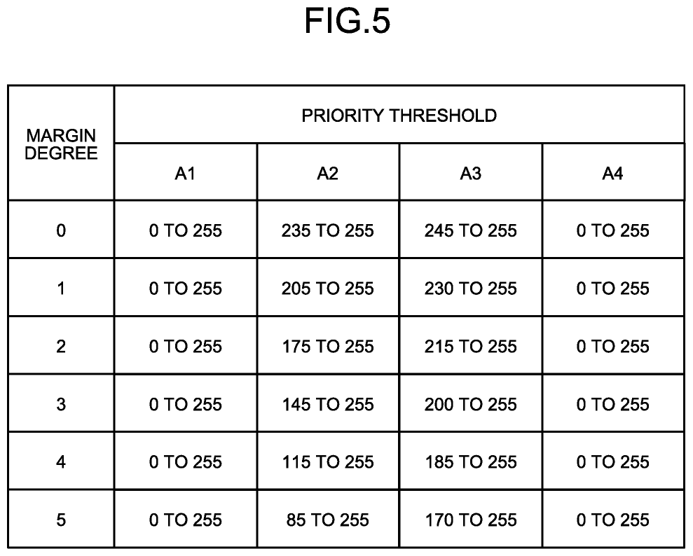

The setting unit 22 statically sets “priority threshold” of the threshold information 31; however, may dynamically set the “priority threshold”, in other words, the threshold may be variable. For example, the setting unit 22 may set a threshold that is according to a margin degree of a driving operation by a driver of the vehicle C. This point will be mentioned later with reference to FIG. 5.

FIG. 5 is a diagram illustrating a set example of a threshold according to a margin degree. The margin degree is an index indicating how much margin a driver has during his/her driving. In FIG. 5, a table is illustrated that indicates relation between “margin degree” and “priority threshold”. In FIG. 5, priority thresholds are set for each of the output units “A1”, “A2”, “A3”, and “A4” (see FIG. 4).

In the table illustrated in FIG. 5, it is indicated that a driver has more margin in his/her driving operation as a value of a margin degree is higher. Specifically, that a margin degree is “0” indicates that a driver is in high-speed running, rounding a curve, or the like and thus has to particularly concentrate on his/her driving operation, and that a margin degree is “5” indicates that a driver is not in performing a driving operation such as parking and thus does not have to concentrate on his/her driving operation.

In other words, a margin degree is computed on the basis of the traveling velocity, the turning angle, and the like of the vehicle C. Furthermore, a level of skill in a driving operation of a driver may be considered with respect to the margin degree in addition to the traveling velocity and/or the turning angle of the vehicle C.

As illustrated in FIG. 5, for example, the setting unit 22 sets, for the output unit “A1”, a threshold “0 to 255” that is always constant regardless of a margin degree. The setting unit 22 sets, for the output unit “A2”, a higher threshold as a margin degree is higher.

In other words, the setting unit 22 makes the threshold higher as a margin of a driving operation of a driver is smaller. Thus, it is possible to output only minimal output information in such a situation where a driver is concentrating on his/her driving operation.

When the output unit 100 is outputting output information, the setting unit 22 may divide the margin degrees illustrated in FIG. 5 into two groups, and may change a priority threshold when the present margin degree changes from one group into the other group.

Specifically, the margin degrees are divided into a first group including margin degrees “0” to “2” and a second group including margin degrees “3” to “5”, and changes a threshold when the present margin degree changes from the first group into the second group. On the other hand, a change in the threshold is forbidden when a change in the margin degree is within the same group.

Thus, it is possible to prevent a threshold from frequently changing in accordance with a change in a margin degree, for example. Therefore, it is possible to prevent output information that is being output from deviating from an output target due to a change in a threshold to frequently change into other output information.

Returning to FIG. 2, the decision unit 23 will be explained. The decision unit 23 decides from among the plurality of output units 100, on the basis of a priority threshold that is set by the setting unit 22, an output destination of output information included in the output request R.

Specifically, the decision unit 23 compares a requesting priority of output information included in the output request R with a priority threshold that is set for each of the output units 100. The decision unit 23 decides, as an output destination, the output unit 100 whose requesting priority is equal to or more than the priority threshold, and outputs the decided output destination to the adjusting unit 25.

The determination unit 24 determines, on the basis of a traveling state of the vehicle C detected by the traveling-state detecting unit 10, whether or not to limit output of the output unit 100. Specifically, when a traveling state of the vehicle C satisfies a predetermined condition, the determination unit 24 limits output of the output unit 100. For example, when the traveling velocity of the vehicle C is equal to or more than a predetermined value, the determination unit 24 determines to limit the output, and outputs a determination result to the adjusting unit 25.

The determination unit 24 may set, for each of the plurality of output units 100 to 102, a corresponding condition to be a determination criterion of output limitation, or may set the same condition for all of the plurality of output units 100. The determination unit 24 may set, for each piece of output information, a corresponding condition to be a determination criterion of output limitation.

When any of the output units 100 to 102 of an output destination that is decided by the decision unit 23 is outputting other output information, the adjusting unit 25 executes, on the basis of priorities, an adjustment for whether to output, in an interrupted manner, output information that is included in the output request R received by the reception unit 21.

Herein, processing details of the adjusting unit 25 will be specifically explained with reference to FIG. 6. FIG. 6 is a diagram illustrating processing details of the adjusting unit 25. In FIG. 6, a case is exemplified in which there presents the output request R including the output information “B”. Furthermore, in FIG. 6, the management information 32 is illustrated, and the management information 32 includes outputting buffers that store therein the output information “A” and “D” presently being output from the output units “A1” and “A2”, and waiting buffers that store therein output information “C” and “E” being suspended. In FIG. 6, assume that the decision unit 23 decides, as output destinations, the output units “A1” and the output units “A2”.

When there presents the plurality of the output units 100 that is decided by the decision unit 23, the adjusting unit 25 more preferentially executes an adjustment on one of the plurality of output units 100 as its threshold is higher. Specifically, as illustrated in FIG. 6, the adjusting unit 25 first executes an adjustment on the output unit “A2” among the output units “A1” and “A2” that are output destinations. Thus, for example, it is possible to more preferentially execute an adjustment on the output unit 100 as its priority threshold is higher, in other words, as its position is in easier view for a driver.

In the output unit “A2”, the adjusting unit 25 executes an adjustment between the output information “A” in the outputting buffer and the output information “B” included in the output request R. Specifically, the adjusting unit 25 compares an output priority of the output information “A” with a requesting priority of the output information “B”.

As illustrated in FIG. 6, an output priority (120) of the output information “A” is higher than a requesting priority (90) of the output information “B”, and thus the adjusting unit 25 continues to output the output information “A” (namely, output information “B” is defeated).

If an output priority of the output information “A” is lower than a requesting priority of the output information “B”, the adjusting unit 25 outputs the output information “B” instead of the output information “A”, in an interrupted manner.

Next, when the output information “B” is defeated as a result of an adjustment with the output information “A”, the adjusting unit 25 executes an adjustment with the output information “C” in a waiting buffer. Specifically, the adjusting unit 25 compares an output priority (110) of the output information “C” with a requesting priority (90) of the output information “B”.

As illustrated in FIG. 6, an output priority of the output information “C” is higher than a requesting priority of the output information “B”, and thus the adjusting unit 25 continues to suspend the output information “C”. If an output priority of the output information “C” is lower than a requesting priority of the output information “B”, the adjusting unit 25 stores the output information “B” in a waiting buffer instead of the output information “C”.

Next, when the output information “B” is defeated as a result of an adjustment with the output information “B”, the adjusting unit 25 executes an adjustment with output information “D” that is being output from the output unit “A1”. In other words, as a result of an adjustment, when the output information “B” included in the output request R is not output from the output unit “A2” in an interrupted manner, the adjusting unit 25 executes an adjustment for whether to cause the other output unit “A1” to output the output information “B” in an interrupted manner. Thus, even when the output information “B” is rejected by the output unit “A2”, it is possible to cause the other output unit “A1” to output the output information “B”.

As illustrated in FIG. 6, similarly to the above-mentioned adjustment, the adjusting unit 25 executes an adjustment between the output information “B” and the output information “D” and an adjustment between the output information “B” and output information “E” in this order. As illustrated in FIG. 6, when the output information “B” is defeated as a result of the adjustment between the output information “B” and the output information “E”, the adjusting unit 25 finally cancels the output of the output information “B”.

In FIG. 6, the adjusting unit 25 executes an adjustment for each of the output units “A2” and “A1”, in other words, adjustments are executed in the order of the output information “A”→the output information “C”→the output information “D”→output information “E”; however, an adjustment order is not limited thereto.

For example, the adjusting unit 25 may execute adjustments on pieces of output information in the outputting buffers, and then may execute adjustments on pieces of output information in the waiting buffers. In other words, the adjusting unit 25 may execute adjustments in the order of the output information “A”→the output information “D”→the output information “C”→the output information “E”.

When it is determined that the determination unit 24 is to limit output from the output unit 100, the adjusting unit 25 outputs, instead of output information that is being output from the output unit 100, limit information indicating information that limits the output. The limit information is information that includes, for example, an image on which a driver of the vehicle C does not concentrate, etc.

In other words, the limit information is output from the output unit 100 in such a situation where a driver of the vehicle C has to concentrate on his/her driving. Thus, for example, it is possible to limit outputting output information, such as an e-mail, for which a driver has to see a screen for a comparatively long period, so that it is further possible to prevent an obstacle to driver's concentration on his/her driving.

When the determination unit 24 releases the limitation of output, the adjusting unit 25 may output previously-output output information instead of the limit information. Alternatively, when a time interval during which limit information is output is equal to or more than a predetermined time interval, the adjusting unit 25 may switch a screen into a predetermined one such as a map screen.

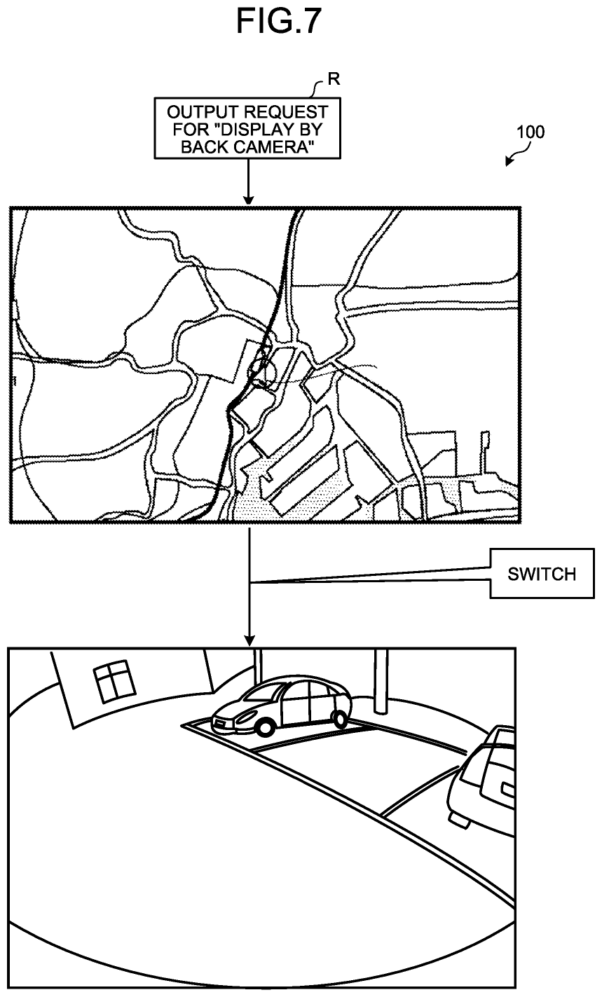

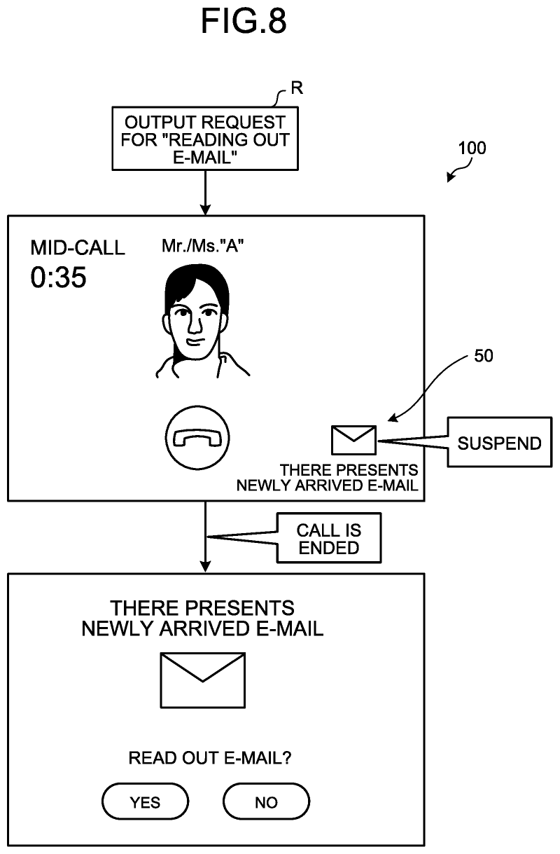

Next, switching examples of the output unit 100 when there presents the output request R will be explained with reference to FIGS. 7 and 8. FIGS. 7 and 8 are diagrams illustrating switching examples of any of the output units 100 to 102. In FIGS. 7 and 8, a case is exemplified where the output unit 100 is a display.

First, switching of a screen in a case where output information included in the output request R wins in an adjustment will be explained with reference to FIG. 7. In FIG. 7, a case is illustrated in which there presents the output request R for “display by back camera” while the output unit 100 is displaying thereon a map screen of a car navigation device.

The output request R for “display by back camera” is generated when a driver of the vehicle C moves a position of a shifter to “reverse”, for example. Image information of a back camera is able to be acquired from a back camera that is arranged in rear portion of the vehicle C, for example.

As illustrated in FIG. 7, when there presents the output request R for “display by back camera” while a map screen is being displayed, the output unit 100 switches a screen into “display by back camera” instead of “display of map screen”.

In other words, the adjusting unit 25 executes an adjustment between the output information indicating “display of map screen” and the output information indicating “display by back camera”, and when “display by back camera” wins in the adjustment, outputs “display by back camera” instead of “display of map screen” in an interrupted manner.

When a driver releases a shifter from “reverse”, the adjusting unit 25 stops “display by back camera” and switches a screen back to “display of map screen”.

Next, a screen switching example when output information included in the output request R is suspended will be explained with reference to FIG. 8. In FIG. 8, a case is exemplified in which an e-mail is received when a mid-call screen indicating mid-call is being displayed on the output unit 100 and there presents the output request R for “reading out e-mail”.

As illustrated in FIG. 8, when there presents the output request R for “reading out e-mail” while a mid-call screen is being displayed, a mid-call screen is continued and a suspending display 50 indicating that “reading out e-mail” is being suspended is displayed in the mid-call screen. After the call has ended, a screen is switched from the mid-call screen into a screen of “reading out e-mail”.

In other words, the adjusting unit 25 executes an adjustment between the output information indicating “displaying mid-call screen” and the output information indicating “reading out e-mail”, continues “reading out e-mail” because “reading out e-mail” is defeated in the adjustment, and stores “reading out e-mail” in a waiting buffer.

When the call has ended, the adjusting unit 25 moves “reading out e-mail” from the waiting buffer to an outputting buffer. When other output information other than “reading out e-mail” is stored in the waiting buffer, an adjustment with the other output information may be executed again.

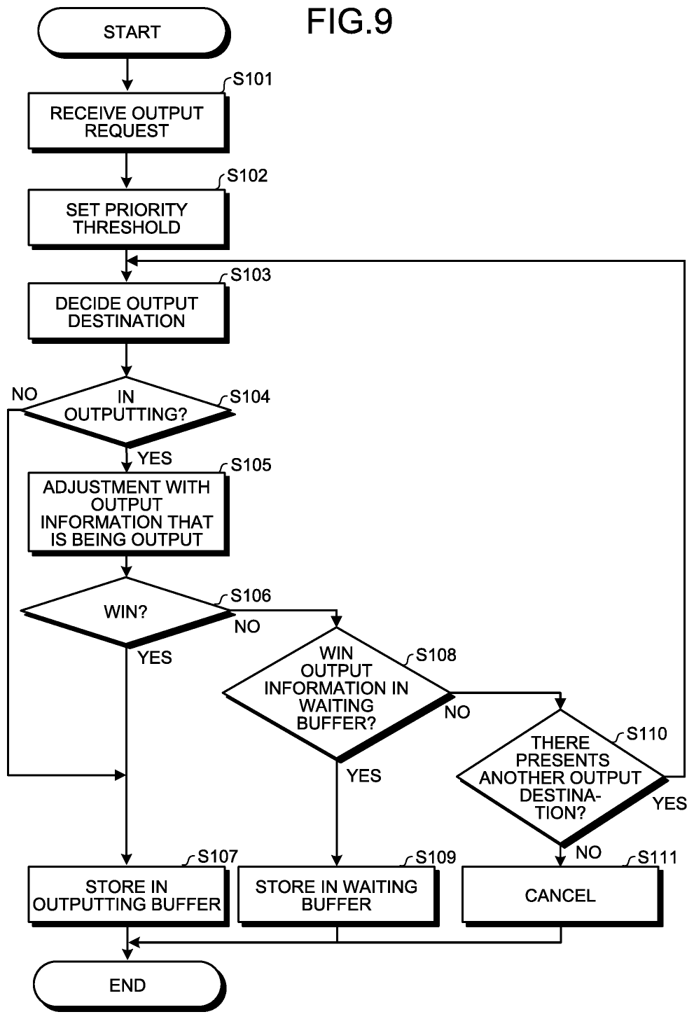

Next, a processing procedure to be executed by the output processing device 1 according to the embodiment will be explained with reference to FIG. 9. FIG. 9 is a flowchart illustrating a processing procedure for a process to be executed by the output processing device 1 according to the embodiment.

As illustrated in FIG. 9, the reception unit 21 receives output information that is output from at least one of the plurality of output units 100 and the output request R that includes information on a priority for outputting the output information (Step S101).

Next, the setting unit 22 sets a priority threshold for each of the plurality of output units 100 (Step S102).

Next, the decision unit 23 decides from among the plurality of output units 100, on the basis of the priority threshold that is set by the setting unit 22, an output destination of the output information included in the output request R (Step S103).

Next, the adjusting unit 25 determines whether or not the output unit 100, which is an output destination decided by the decision unit 23, is outputting other output information (Step S104).

When the output unit 100, which is an output destination, is outputting the output information (Step S104: Yes), the adjusting unit 25 executes an adjustment with the output information that is being output (Step S105). Specifically, the adjusting unit 25 executes, on the basis of a priority, an adjustment for whether to output, in an interrupted manner, the output information included in the output request R received by the reception unit 21.

Next, the adjusting unit 25 determines whether or not the output information included in the output request R has won as a result of the adjustment (Step S106). When the output information included in the output request R has won (Step S106: Yes), the adjusting unit 25 stores the output information in an outputting buffer of the management information 32 (Step S107), and ends the processing.

On the other hand, in Step S104, when the output unit 100, which is an output destination, is not outputting other output information (Step S104: No), the adjusting unit 25 shifts the processing into Step S107.

In Step S106, when the output information included in the output request R is defeated (Step S106: No), the adjusting unit 25 executes an adjustment with output information stored in a waiting buffer so as to determine whether or not the output information included in the output request R wins as a result of the adjustment (Step S108).

When the output information included in the output request R has won (Step S108: Yes), the adjusting unit 25 stores the output information in a waiting buffer (Step S109), and ends the processing.

On the other hand, in Step S108, when the output information included in the output request R is defeated (Step S108: No), the adjusting unit 25 determines whether or not there presents the output unit 100 that is another output destination on which an adjustment has not yet been executed (Step S110).

When there presents the output unit 100 that is another output destination on which an adjustment has not yet been executed (Step S110: Yes), the adjusting unit 25 shifts the processing to Step S103. On the other hand, when there presents no output unit 100 on which an adjustment has not yet been executed (Step S110: No), the adjusting unit 25 cancels the output request R in the output information (Step S111), and ends the processing.

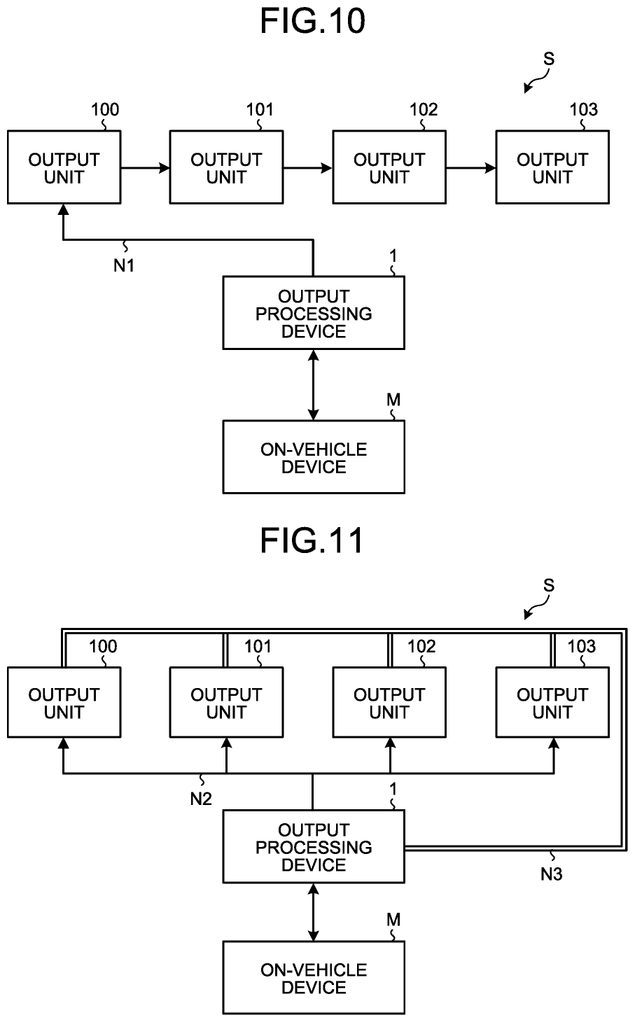

Next, an output processing system S will be explained with reference to FIGS. 10 and 11. FIGS. 10 and 11 are diagrams illustrating configurations of the output processing system S according to the embodiment. In FIGS. 10 and 11, a case is exemplified in which the output processing system S includes the four output units 100 to 103.

In FIGS. 10 and 11, there are illustrated different transmission systems from the output processing device 1 to the output units 100 to 103. First, FIG. 10 will be explained. As illustrated in FIG. 10, the output processing system S includes the on-vehicle device M, the output processing device 1, and the output units 100 to 103. The number of the on-vehicle devices M may one or more.

In the example illustrated in FIG. 10, the output processing device 1 is connected to one of the plurality of output units 100 to 103, and data is transmitted therebetween through a transmission system N1. The output processing device 1 transmits, to the output unit 100, pieces of output information that are output from all of the plurality of output units 100 to 103 through the transmission system N1.

The output unit 100 outputs output information of the output unit 100 among from the acquired pieces of output information of the plurality of output units 100 to 103, and further transmits remaining pieces of the output information to the output unit 101.

The output unit 101 outputs output information of the output unit 101 among from the acquired pieces of output information of the plurality of output units 101 to 103, and further transmits remaining pieces of the output information to the output unit 102. Corresponding pieces of output information are similarly output from the output unit 102 and the output unit 103.

3) In other words, the output processing system S illustrated in FIG. 10 includes the transmission system N1 that is capable of collectively transmitting all pieces of output information from the output processing device 1 to the one output unit 100. Thus, it is possible to transmit output information to the plurality of output units 100 to 103 without complicated wiring.

Next, FIG. 11 will be explained. In the example illustrated in FIG. 11, the output processing device 1 is connected to each of the output units 100 to 103 by using two transmission systems N2 and N3. The transmission system N2 transmits pieces of output information respectively corresponding to the output units 100 to 103. The transmission system N3 is a transmission system with the use of, for example, a Controller Area Network (CAN), and transmits therethrough control signals for controlling the plurality of output units 100 to 103, etc.

Thus, the output processing device 1 does not require any high-performance component for collectively transmitting a plurality of pieces of output information, so that it is possible to reduce the product cost of the output processing device 1.

As described above, the output processing device 1 according to the embodiment includes the reception unit 21, the setting unit 22, the decision unit 23, and the adjusting unit 25. The reception unit 21 receives the output request R including (i) output information that is to be output from at least one of the plurality of output units 100 and (ii) information on a priority for outputting the output information. The setting unit 22 sets a threshold of the priority (priority threshold) for each of the plurality of output units 100. The decision unit 23 decides from among the plurality of output units 100, based on the priority threshold set by the setting unit 22, an output destination of the output information included in the output request R. The adjusting unit 25 executes based on the priority, when the output unit 100, which is the output destination decided by the decision unit 23, is outputting other output information, an adjustment of whether to output, in an interrupted manner, the output information included in the output request R received by the reception unit 21. Thus, it is possible to prevent the plurality of output units 100 from simultaneously outputting pieces of output information, and further to output information that is important for a driver from the appropriate output unit 100. In other words, it is possible to appropriately distribute output destinations of information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### REFERENCE SIGNS LIST

1 output processing device
2 control unit
3 storage
10 traveling-state detecting unit
21 reception unit
22 setting unit
23 decision unit
24 determination unit
25 adjusting unit
31 threshold information
32 management information
100 to 103 output unit
M1, M2 to Mn on-vehicle device

1. An output processing device comprising:
a reception unit that receives an output request including (i) output information that is to be output from at least one of a plurality of output units and (ii) information on a priority for outputting the output information;
a setting unit that sets a threshold of the priority for each of the plurality of output units;
a decision unit that decides from among the plurality of output units, based on the threshold set by the setting unit, an output destination of the output information included in the output request; and
an adjusting unit that executes based on the priority, when the output unit, which is the output destination decided by the decision unit, is outputting other output information, an adjustment of whether to output, in an interrupted manner, the output information included in the output request received by the reception unit.

2. The output processing device according to claim 1, wherein
when a number of the output units decided by the decision unit is two or more, the adjusting unit more preferentially executes the adjustment on one of the two or more output unit as its threshold is higher.

3. The output processing device according to claim 2, wherein
when the output unit is not to output, in an interrupted manner, the output information included in the output request as a result of the adjustment, the adjusting unit executes the adjustment of whether to cause another of the plurality of output units to output, in an interrupted manner, the output information.

4. The output processing device according to claim 1, wherein
the plurality of output units is provided in a vehicle, and
the setting unit sets the threshold according to a margin degree of a driving operation performed by a driver of the vehicle.

5. The output processing device according to claim 4, further comprising:
a determination unit that determines, based on a traveling state of the vehicle, whether or not to limit outputting from the output unit, wherein
when the determination unit determines to limit outputting from the output unit, the adjusting unit outputs, instead of the output information that is being output from the output unit, limit information that indicates information on limiting the outputting.

6. An output processing method comprising:
receiving an output request including (i) output information that is to be output from at least one of a plurality of output units and (ii) information on a priority for outputting the output information;
setting a threshold of the priority for each of the plurality of output units;
deciding from among the plurality of output units, based on the threshold set in the setting, an output destination of the output information included in the output request; and
when the output unit, which is the output destination decided in the deciding, is outputting other output information, executing, based on the priority, an adjustment of whether to output, in an interrupted manner, the output information included in the output request received in the receiving.
